(19) United States
(12) Patent Application Publication
(10) Pub. No.: US 2009/0304872 A1
(43) Pub. Date: Dec. 10, 2009

(54) Packaging for Food Products

(75) Inventor: Sidi Chouikhi, Finedon (GB)

Correspondence Address: BUCHANAN, INGERSOLL & ROONEY PC, POST OFFICE BOX 1404, ALEXANDRIA, VA, 22313-1404, US

(73) Assignee: HJ HEINZ COMPANY LIMITED, Middlesex (GB)

(21) Appl. No.: 12/226,006

(22) PCT Filed: Apr. 2, 2007
(86) PCT No.: PCT/GB2007/001217

§ 371 Date: Jul. 20, 2009

(30) Foreign Application Priority Data
Apr. 3, 2006 (GB) 0606676.5

(51) Int. Cl. B65D 81/34; H05B 6/64; B65B 3/04; B65D 85/72; B32B 37/00; B29C 65/00

(52) U.S. Cl. 426/107; 219/730; 53/467; 264/134; 264/135; 156/60

(57) ABSTRACT

Provided is a packaging for facilitating microwave heating arranged to contain a food product up to a fill level within the packaging, which packaging comprises: a) a first metallic microwave active component, extending above and below the fill level; and optionally b) a second metallic microwave active component, extending above and below a base level.

The present invention concerns packaging for a food product, specifically, packaging for a food product that can be heated in a microwave. The invention also concerns a method for making the packaging, a method for packaging a food product, and food products packaged using the packaging and methods of the invention.

In particular, the present invention concerns packaging for soups, meals and meal components that can be heated in the microwave.

Changes in work patterns and lifestyles in modern societies have powered the demand by consumers for foods that provide convenience and quality. The growth in frozen, chilled and ambient stable ready meals, meal components and convenience foods, which can be re-heated rapidly in microwave ovens, has gone part of the way towards meeting these demands. Microwaves offer the advantage over conventional heating methods of significantly reduced heating times. However, the variability in quality of foods re-heated or cooked in a microwave remains a key obstacle in the way of the wider appeal of these types of foods.

Specifically, the advantages of microwave ovens are often negated by the fact that when using standard board or plastic packaging the results from heating in microwaves are often less than satisfactory. The heating of the food is often uneven, parts of the product being inadequately heated while other parts, in particular the edges of the product, being overheated. Water within the heated area starts to boil. Where a film over the product is used, the moisture is caught and eventually condenses on the product surface making it impossible to obtain browning. Where the film is removed during heating, the moisture is lost and the product is dried out. This results in a lower quality product.

Various approaches have been used over the years to overcome these problems. At the heart of these approaches has been the use of patches of metal film integrated into what might be termed “microwave inert packaging”, for example into board and plastics etc. Metal films (e.g. commercially available aluminium foil of thickness >7 μm) reflect microwaves almost totally. These types of films can be used in design patches of varying complexities to modify local electric field patterns and/or partly or fully shield parts of the product from being subjected to microwaves.

Attempts at using metallised packaging to modify and control the heating of foods in microwave ovens dates almost as far back as the use of microwaves to heat foods. However, these attempts have met with only limited success, partly because they have been empirically based and partly because of the widespread belief that the use of metallic packaging can be detrimental to the functioning of microwave appliances and may be unsafe.

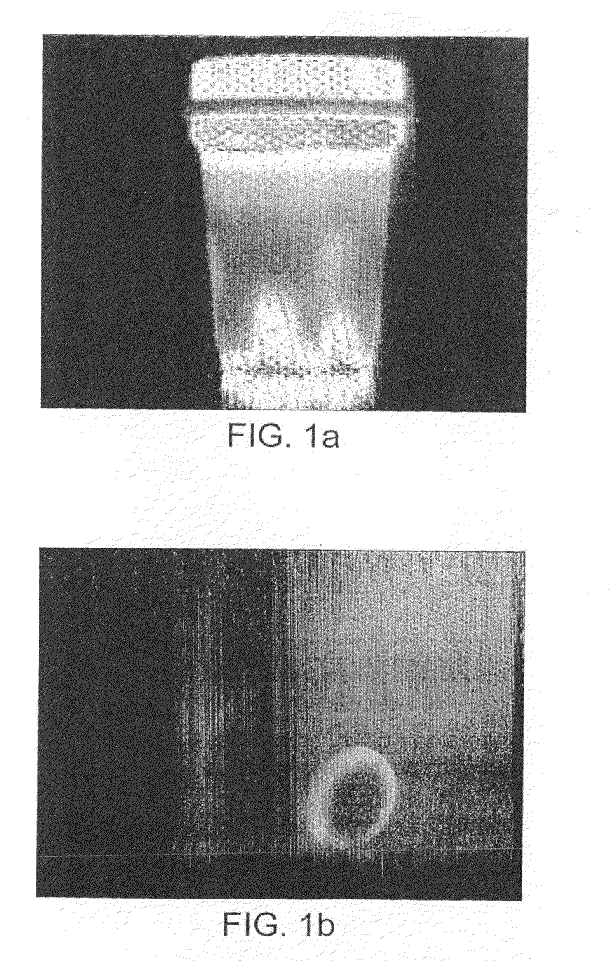

This is particularly a problem with wet foods, which often have high microwave absorption and low microwave penetration (transparency to microwaves) characteristics. For microwaveable soup products, for example, the re-heating performance of current single serve soup products on the market is variable. Re-heating of these products tends to be non-uniform and for some variants may also be accompanied by strong sputtering at the top of the product and bumping at the base of the cup which occasionally leads to toppling of the cup. Infrared thermal images taken during the re-heating of one example of this product in a 700W microwave oven shows strong heating around the base and top of the product (see FIGS. 1a and 1b). Moreover, the heating tends to be concentrated on the outer layers of the product because of the inherently high dielectric loss properties of soups. Therefore, some areas of the product/packaging may become overheated during microwave heating and as a result there is a risk of burning from handling or consuming the heated product.

To address these problems manufacturers often include instructions for the consumer to introduce “stand times” both during and after product heating, before consumption. It is commonly believed that during these periods heat spreads by conduction from overheated areas to cooler ones. However, this spread of heat by conduction is slow and not efficient, and extends the overall time required for product heating.

Previous attempts to provide solutions to the problems of microwave heating have been disclosed in U.S. Pat. No. 4,013,798, U.S. Pat. No. 4,268,738, U.S. Pat. No. 4,656,325, U.S. Pat. No. 4,990,735, U.S. Pat. No. 5,117,078, U.S. Pat. No. 5,593,610, U.S. Pat. No. 6,102,281 and U.S. Pat. No. 6,204,492, but have met with limited success.

The present invention aims to overcome the disadvantages of the prior art packaging, and in particular to provide an improved packaging for a food product, which allows the food product to be heated in the packaging in a microwave to produce a suitably heated/cooked product.

In particular, the present invention aims to:
(i) eliminate the strong ring like heating pattern at the base of the product;
(ii) introduce a more even heating pattern at the base of the product;
(iii) eliminate the strong ring like heating pattern at the top of the product;
(iv) introduce a more even heating pattern and slower heating rates at the top of the product;
(v) introduce heating patterns in the vertical direction in liquid products, such as soups, which enhances the uniformity of the direct heating and induced natural convection flows to further improve the uniformity of heating;
(vi) reduce overheating of the packaging;
(vii) introduce time variable heating patterns which induce intermittent localised heating and reduce the risks of sputtering, bumping and boiling with liquid products, and inappropriate burning and/or browning with solid products;
(viii) create consistency between the results of heating the same product in different microwave ovens; and
(ix) increase the efficiency of microwave heating such that heating times are reduced.

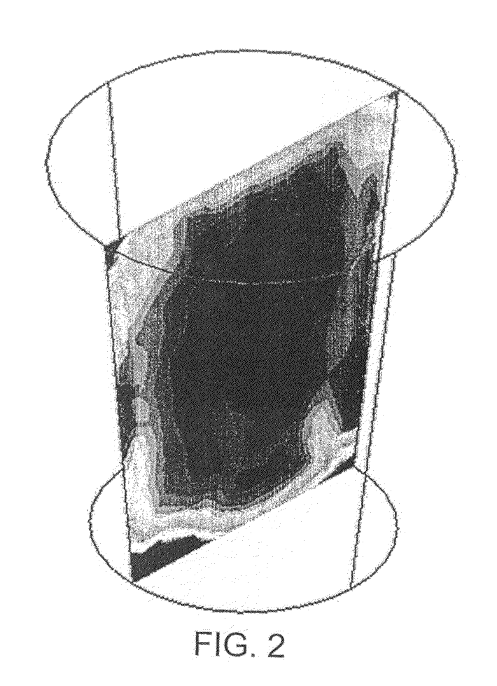

The inventors have now developed computer models to simulate the interactions of the food product in a microwave oven with the microwaves. In particular, the models can be used to simulate the interactions of a cup of soup in a microwave oven with the microwave (electric) field as the cup rotates in the cavity of a (Panasonic Genius) microwave oven. The results of the simulations (see FIG. 2) show similar characteristic coupled power density profiles to the temperature profiles observed by infrared thermal imaging in the early stages of the re-heating of the soup. The microwave power coupled into the soup is in excess of two orders of magnitude higher around the rings at the top and base than at the core of the product, which clearly leads to sputtering at the top and is the initiating cause of bumping at the base. In achieving the above aims the present invention provides a packaging for facilitating microwave heating arranged to contain a food product up to a fill level within the packaging, which packaging comprises:
a) a first metallic microwave active component, extending above and below the fill level; and optionally
b) a second metallic microwave active component, extending above and below a base level.

According to one aspect of the invention the first microwave active component extends at least 6 mm above the fill level and/or the second microwave active component extends at least 6 mm above the base level. More preferably the first microwave active component extends between 6 mm and 18 mm above the fill level and/or the second microwave active component extends between 6 mm and 18 mm above the base level.

Preferable the first microwave active component is not part of any lid or cover. If the microwave active component is part of the lid or cover in some cases it is possible for the lid and therefore the component to be incorrectly positioned with respect to the food product.

In a preferred aspect of the invention the one or more edges of the first microwave active component above and/or below the fill level are substantially straight and/or one or more edges of the second microwave active component above and/or below the base level are substantially straight. More preferably the one or more edges of the microwave active component above and/or below the fill level are shaped and/or one or more edges of the second microwave active component above and/or below the base level and shaped. In particular the shaped edges are preferably undulating. In one arrangement according to the present invention the second microwave active component in extending below the base level extends along at least a portion of the bottom of the packaging. In particular, the second microwave active component extends from 5 mm to 25 mm along the bottom.

In an alternative arrangement, the packaging for microwave heating further comprises a plinth, which encloses a cavity below the base level of the packaging, and the second microwave active component in extending below the base level extends downwards along the plinth. Preferably the plinth is at least 6 mm high.

In a preferred aspect of the present invention the first and second metallic microwave active components are joined to form a single component. Further the single component may contain a plurality of windows, the windows being defined by one or more holes in the component.

In a specific aspect of the present invention, the packaging contains a plurality of windows whose dimensions and locations are adapted so as to be suitable for microwave heating a liquid food product, in particular, a single serve soup wherein the packaging comprises a cup with a lid. In this embodiment the cup is 80 to 110 cm in height with a maximum diameter of 80 to 100 cm. However, these dimensions are by no means limiting and the invention may be applied to any container size. In general the functionality stems from inter alia the specific heights of the active components below and above fill levels, the height of the plinth, the height above base level etc rather than the dimensions of the vessel itself.

In one embodiment of the present invention, the packaging is in the form of a cradle, capable of being placed around a microwave inert container that contains the food product. Preferably the packaging in the form of a cradle is reusable. Accordingly, the present invention also covers the use of such a cradle to heat a food product in a microwave.

In a specific aspect of the packaging according to the present invention the first and/or second metallic microwave active components comprise a metal film or foil. Preferably the metal film or foil is an aluminium or copper film or foil. More preferably the aluminium film or foil is at least 1 μm thick and the copper film or foil is at least 0.6 μm thick. Any thickness of aluminium above 1 μm is equally effective at shielding the product in the manner required by the present invention and therefore the maximum thickness of the sheet is only limited above this value by the cost. Similarly to the aluminium film, any thickness of copper above 0.6 μm is effective at shielding the product in the manner required by the present invention.

Further the present invention provides a method of manufacturing a packaging for facilitating microwave heating for a food product, which method comprises the steps of:
(a) laminating or depositing a metallic microwave active component onto a support to produce a metallised element; and
(b) forming a packaging as described above from the metallised element.

In a preferred aspect of the present invention the metallised element is incorporated into the packaging by in-mould labelling. More preferably, it is incorporated into the packaging by barrier in-mould labelling.

In one embodiment the metallised element is a collar or a label to be placed around the packaging. In this embodiment the label may be an adhesive label.

Alternatively, the metallised element is a holder for the food container or packaging (in the manner of a coffer cup holder).

In a further embodiment the invention provides a packaged food product comprising a food product packaged up to the fill level in the packaging for facilitating microwave heating as defined above.

Still further, the present invention provides a method for packaging a food product comprising the steps of:
(a) filling a packaging for facilitating microwave heating as defined above; and
(b) sealing the packaging to package the food product.

In addition the present invention provides for the use of a packaging for microwave heating as described above to heat a food product in a microwave, wherein the food product is present in the packaging up to the fill line.

The present invention will now be described in more detail by way of examples only with reference to the following Figures, in which,

FIG. 1a shows a snapshot infrared thermal image showing the heating pattern in a single serve soup of the prior art;

FIG. 1b shows a snapshot infrared thermal image showing the heating pattern in a single serve soup of the prior art that has been toppled by the heating process;

FIG. 2 shows a coupled power density profile in a plane through the body of a single serve soup of the prior art, during re-heating;

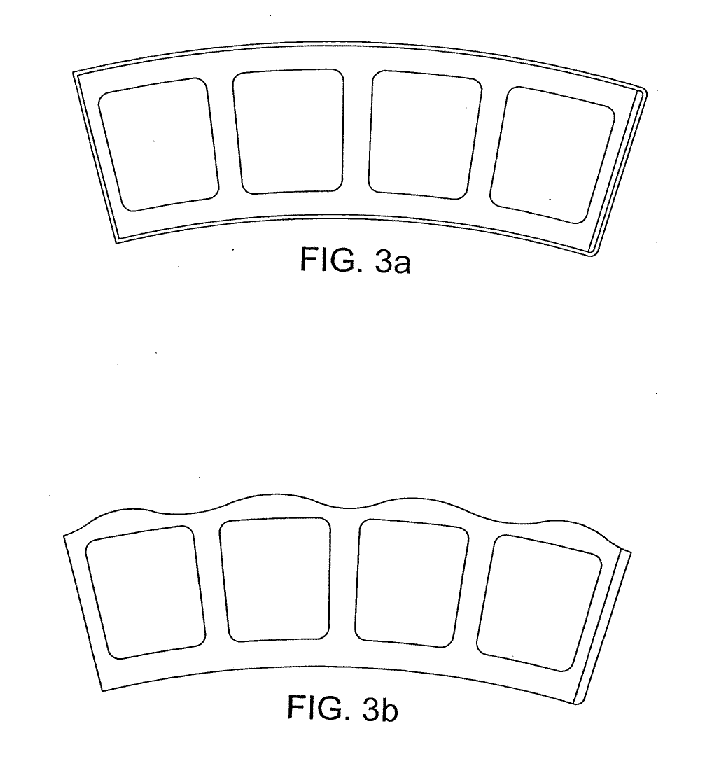

FIGS. 3a and 3b show sample outline designs for the metallised pattern of the microwave active components in two embodiment of the present invention, for use as stick-on labels for the cup packaging of single serve soups;

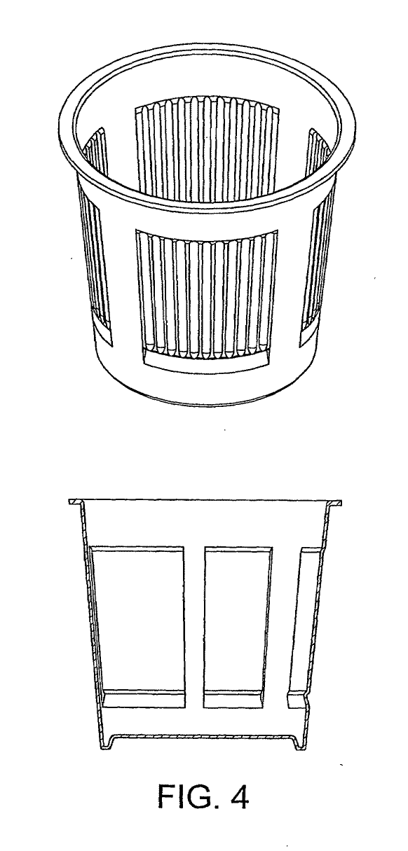

FIG. 4 shows an example of the cup design, which is to incorporate the stick-on labels of FIGS. 3a and 3b in an embodiment of the invention; and

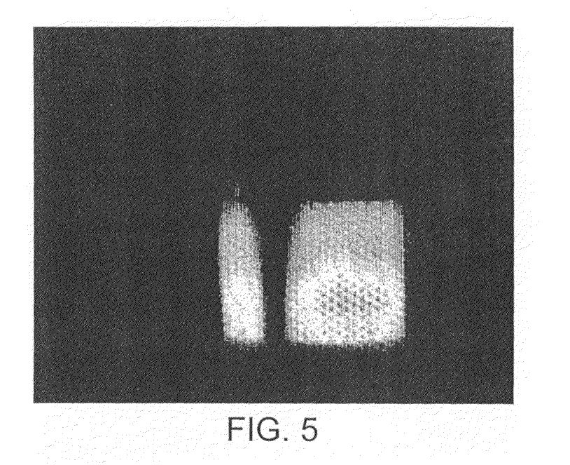

FIG. 5 shows a snapshot infrared thermal image showing the heating pattern in a cup of single serve soup which incorporates a microwave active component according to the present invention.

The present invention provides a packaging for microwave heating arranged to contain a food product up to a fill level within the packaging, which packaging comprises a metallic microwave active component, wherein at least a first portion of the microwave active component extends above the fill level.

The fill line or fill level of a packaging is the level at the side of the packaging that the food product is to be filled to (effectively the maximum level or the target level for filling). For liquid products the product in the package will generally all be at the same height—the fill level—although there may be a small variation as a result of a meniscus—(this variation is well understood by those skilled in the field). For solid products, however, the top layer of the product although being at the same height as the fill level at the points of contact with the packaging may be higher or lower than the fill level away from the side of the packaging i.e. the surface of the product may be convex or concave.

The base level of a packaging is the lowest level at which the food product is situated. Where the packaging does not comprise a plinth the base level may also be defined by the bottom of the packaging. However, where the packaging comprises a plinth, the base level will be raised by the plinth above the bottom of the packaging.

As described above, the edges of the first and second microwave active components both above and/or below the base level and fill level may be substantially straight or shaped. In the present context straight means not deviating i.e. remaining substantially equidistant from the fill or base level. A substantially straight edge of the first microwave active component can be parallel with the fill level and/or the upper edge of the packaging. A substantially straight edge of the second microwave active component can be parallel with the base level and/or the bottom of the packaging.

These edges may also be shaped i.e. not straight. A shaped edge can be in an irregular pattern in which the movement of the edge up and down is random. Preferably, however, the shaped edge is regular and may therefore be in the form of waves. These may not necessarily be curvilinear and can be in any form provided that there are no sharp points (to prevent arcing). Preferably they are curvilinear, rising and falling in the manner of a sine wave. In particular, the shaped edges are undulating, presenting a waved appearance, rising and falling in a continuous manner. For an undulating edge, the lowest point of the edge should preferably be above the fill level. Preferably, the lowest point of the edge is at least 6 mm above the fill level and the highest point is 18 mm above the fill level. More preferably the undulation forms a continuous (non-ending) wave around the packaging.

In particular the microwave active component comprises metallic surfaces which are highly electrically conductive, and of a suitable thickness which preferably perfectly or near perfectly reflect the electromagnetic waves of the microwave oven. The metal employed is not especially limited provided that it has this function. Preferably these metallic surfaces are either:
1. Thin metal foil, preferably copper or aluminium foil of thickness ≧0.6 μm (because of their respective effective electrical conductivity, that of copper being higher than that of aluminium, the minimum thickness is 0.6 μm for cooper and 1 μm for aluminium); and/or
2. Patterns of thin copper (metal) film, of thickness ≧0.6 μm, deposited onto a supporting polymer film or substrate through a metal deposition process (QinetiQ™ Metal Printing Process developed to produce Radio Frequency Identification Devices (RFID)).

These metallic surfaces provide the required functionality, in that they are able to perfectly or near perfectly reflect electromagnetic waves (microwaves) and are compatible with microwaves. Accordingly, they are capable of influencing electric field patterns to which the food product is exposed when the food product is subject to microwave heating.

The metallic sheet is shaped in a particular pattern, required to achieve the desired functionality and produce the target improvements in microwave re-heating quality. In a preferred embodiment of the invention these surface patterns are used in combination with shielding and a plinth within the packaging.

In particular in the prior art it is accepted practice to include a metallised layer within the packaging that is at or below the maximum level of the food. It is thought that extending the edge of the metallised layer above this point will result in burning of the packaging, and an unattractive product appearance. However, the present inventors have discovered that advantageous effects result when the metallic sheet in the packaging suitable for microwave heating extends above the level of the food product.

This creates a more even heating pattern and slower and more even rates of heating at the top of the product and eliminates the strong ring like heating pattern at the top of the product. In particular, the microwaves can be more randomly scattered across the surface of the food product, giving a greater likelihood of covering the surface of the food in the middle of the product, if the top edge of the metallic sheet is shaped so as to be undulating.

Further, if the surface of the food can be made rough, this aids even heating.

An additional effect can be created at the bottom of the product by using a plinth or extending the metallic sheet down at least a part of one or more sides of the packaging and along at least a portion of a base of the packaging. In particular, if a plinth is used the turntable and the sides of the plinth form a reflective box which will partially reflect the microwaves back into the product, creating more even heating around the base of the product.

Further, the metallic sheet can include windows, positioned in the sides of the packaging for microwave heating. Windows are preferably used when the packaging for microwave heating is a pot. Where the packaging is a tray, windows are preferably not used. In the present context, the distinction between a pot (which is a tall vessel, that may be rectangular or round); and a tray (a vessel short in height, that may be round or rectangular), is derived from the ratio of the height of the vessel (from the base level to the top edge) to the shortest distance from any side of the vessel to its centre. If the ratio is >1 then the vessel is defined as a pot and preferably requires side window for more even microwave heating. If the ratio is ≦1 then the vessel is defined as a tray and would not necessarily require side windows to effect move even microwave heating.

Where windows are provided, these allow microwaves through the metallic sheet, whereas the bands block them. The present inventors have discovered that the windows allow heating in particular areas of the food product, such that some areas become hotter than others. Where the product is a liquid product, such as a soup, this leads to heat transfer by convention within the product, forcing the heat to move to cooler parts of the product. Preferably the window configuration is selected to maximise convention within a liquid food product.

The microwave active components are selected so as to be suitable for lamination with other materials (board, paper and polymer films) so that they can be easily and readily integrated into a range of standard food packaging formats. The metallic foil or metallic film and polymer construction is laminated onto a layer of, or between two layers of, suitable material(s) prior to use with or incorporation into standard food packaging. Lamination is a well established process which involves the application of an adhesive layer on one surface of the two materials to be laminated together and the bringing together of the two materials to glue them by passing them between rollers.

In a preferred aspect of the present invention the metallic foil or metallic film and polymer construction are laminated with board and/or paper and/or polymer films. A polymer film may be of polyethylene or polypropylene, preferably between 20 to 30 μm thick. More preferably, the polymer film is about 25 μm thick. Board and paper would be any feed board, or paper with a moisture and/or fat barrier used for the manufacture of food contact packaging/containers. Alternatively, the metallic film and polymer constructions may be used with, or incorporated into, standard food packaging. Standard packaging includes thermoformed crystalline polyethylene terephthalate (CPET) or polypropylene (PP) containers, injection moulded PP containers and pressed board trays and folded board trays.

In a preferred aspect of the present invention the metallised pattern is positioned in relation to the product (and not the container).

Further the present invention provides alternative methods of making packaging for microwave heating. In one aspect the microwave active components may be used in the form of stick-on microwave active labels with standard food packaging, multi-layered board constructions forming microwave active trays, containers or cradles. Alternatively, the microwave active components may be in the form of collars, sheaths, jackets or coverings to be placed around non-microwave active food packaging.

In particular, the present invention encompasses the use of the packaging of the present invention as a cradle, support of receiver into which the food product, already contained in microwave inert packaging, can be inserted to facilitate microwave heating. The packaging is capable of being placed around the microwave inert containers that contain the food product, in such a way as to house or hold it.

Further, the present invention provides a method in which the microwave active labels are moulded (Injection Moulded Labels) within the body of injection moulded polypropylene (PP) containers (containers (cups and trays) made of PP are suitable for microwave heating only and cannot withstand temperatures of conventional ovens). In-mould labelling involves the placing of a pre-formed/pre-cut label into the container mould followed by the injection of heated and molten PP into the mould to form the containers. On cooling the label is embedded into the body (walls) of the container.

The in-mould labelling preferably involves the use of labels with mechanical, physical and/or chemical barrier functions to protect the food product in the container. In particular, materials that prevent the permeation of water or air can be used.

In a particular embodiment of the invention the food product is an edible substance which can include ambient stable, chilled or frozen soups, meal components (e.g. pasta sauces) or complete meals (e.g. lasagne, curry sauce and rice) and the packaging is a container/vessel comprises the features of:
(i) shielding of the lower section of the container;
(ii) a shielded plinth on the container to create a cavity below the base of the product to induce multiple microwave reflections;
(iii) shielding of the upper section of the product, which also extends above the level of the product;
(iv) window patterns in the shielding to induce heating patterns which induce natural convection flow in a semi-liquid or liquid product; and
(v) undulating patterns on the top edge of the shielding patterns to induce mode stirring (in a semi-liquid or liquid product) and enhance uniformity of (time averaged) electric field patterns on the top surface of the product.

The dimensions of the plinth, the height of the shielding in relation to the product levels, and the dimensions of the windows in the shielding are not especially limited, provided that the function of the packaging for microwave heating is not impaired and the advantages of the present invention are not lost.

Attenuation of the excessive heating around the top edge of the product is preferably achieved by using a shielding band, which extends below and above the product fill line. The height above the fill line to which the shielding band extends is key in determining the uniformity of heating on the top surface. The use of undulating top line on the metallised band further enhances the uniformity of heating at the top surface (mode stirring) and produces intermittent heating.

Attenuation of the excessive heating around the base of the product is preferably achieved by (a) raising the base of the product (on a plinth) (b) using a shielding band, which extends above the base level of the product and down the full height or as close to the full height of the plinth as practicable. The cavity enclosed by the plinth below the base of the product induces multiple reflections of the waves and enhance the uniformity of heating through the base. The height of the cavity is a key parameter in controlling the heating rates achieved at the base of the product.

The use of upright metallised spines has the following effects (a) further inducing mode stirring and intermittently changing the electric field patterns around the product (b) enhancing heating in the vertical (axial) direction (c) inducing heating patterns which enhance product flow and mixing through natural convection and localised boiling.

The preferred characteristic dimensions of the metallised patterns are defined in relation to the fill level and the base level of the product and are given in table 1.

| | | | | Preferable range |
|---|---|---|---|---|
| | | Typical | | of dimensions |
| | | dimensions | | (mm) |
| Top | Height above | about 6 | mm | 3-12 |
| shielding | product fill | | | |
| band | Height below | about 6 | mm | 3-12 |
| | product fill | | | |
| | Undulating edge | about 6 | mm | 6-12 |
| | amplitude | | | |
| | Undulating edge | about 24 | mm | 24-36 |
| | cycle | | | |
| Bottom | Height above | about 6 | mm | 3-12 |
| shielding | product base | | | |
| band | Height below | about 12 | mm | 6-18 |
| | product base | | | |
| Upright | Number | 4 | | 4-8 |
| spines | Width | 12 | mm | 6-12 |

The present invention can be applied to any packaging for microwave heating, such as packaging for soups, meals and meal components. In one embodiment the packaging of the present invention can be used to package ambient stable foods. Ambient stable foods are defined as those which are commercially sterile under the intended temperature conditions of storage. Refrigerated storage is not required. In particular, ambient stable foods are commercially sterile at temperatures above 8° C., and particularly those that are commercially sterile at room temperature.

In another embodiment the packaging of the present invention can be used to package chilled foods. Chilled foods are defined as those which require storage and distribution at temperatures ranging between 0° C. to 8° C., preferably between 5° C. and 8° C.

In another embodiment the packaging of the present invention can be used to package frozen foods. Frozen foods are defined as those which require storage and distribution at temperatures below 0° C., preferably at temperatures below −18° C.

Further, the present invention can be used to package food products that are solid at their consumption temperature, e.g. lasagne and shepherd's pie, to package products that are liquid at their consumption temperature, e.g. soups and sauces, and to package food products that are a mixture of solid and liquid components at their consumption temperature, e.g. pasta and sauce, protein, vegetables and sauce.

### EXAMPLES

Examples of designs for the metallised pattern in the microwave active component of single serve soup packing according to embodiments of the present invention are shown in FIG. 3a and FIG. 3b. These components are designed as part of stick-on labels which to be applied to the cup design illustrated in FIG. 4.

The labels are made from a composite structure comprising of aluminium foil laminated onto paper and cut according to the design shape to form labels which are then stuck on the containers to provide the required microwave functionality. Alternately the labels may be embedded into the walls of the containers (in-mould labelling process) to provide the required microwave functionality.

The advantages of the present invention can be seen in FIG. 5, which shows a snapshot of an infrared thermal image showing the heating pattern in a single serve soup that incorporates a microwave active component according to the present invention. The image shows the improved heating pattern. Specifically, the consumer perceived benefits are as follows:
Elimination of bumping during reheating
Reduction and in some instances elimination of sputtering of product at the top of the container
Improved uniformity of heating
Elimination of the need to stand the product after heating and prior to consumption
Reduction of risk of burning from handling of heated product
Reduction of risk of burning on consumption of product

Example applications include the re-heating of sauces and snacks (rice and sauce or pasta and sauce) in pots/cups, meals components (curry dishes, oriental dishes) or complete meal dishes (e.g. lasagne, shepherd pies, pasta and sauce dishes) in trays.

1. A packaging for facilitating microwave heating arranged to contain a food product up to a fill level within the packaging, which packaging comprises:
a) a first metallic microwave active component, extending above and below the fill level; and optionally
b) a second metallic microwave active component, extending above and below a base level.

2. A packaging for facilitating microwave heating according to claim 1 wherein the first microwave active component extends at least 6 mm above the fill level and/or the second microwave active component extends at least 6 mm above the base level.

3. A packaging for facilitating microwave heating according to claim 2 wherein the first microwave active component extends between 6 mm and 18 mm above the fill level and/or the second microwave active component extends between 6 mm and 18 mm above the base level.

4. A packaging for facilitating microwave heating according to claim 1 wherein one or more edges of the first microwave active component above and/or below the fill level are substantially straight and/or one or more edges of the second microwave active component above and/or below the base level are substantially straight.

5. A packaging for facilitating microwave heating according to claim 1 wherein one or more edges of the first microwave active component above and/or below the fill level are shaped and/or the one or more edges of the second microwave active component above and/or below the base level are shaped.

6. A packaging for facilitating microwave heating according to claim 5 wherein the one or more edges or the first microwave active component and/or the second microwave active component are undulating.

7. A packaging for facilitating microwave heating according to claim 1 wherein the second microwave active component in extending below the base level extends along at least a portion of the bottom of the packaging.

8. A packaging for microwave heating according to claim 7 wherein the second microwave active component extends from 5 mm to 25 mm along the bottom of the packaging.

9. A packaging for facilitating microwave heating according to claim 1 wherein the packaging further comprises a plinth which encloses a cavity below the base level of the packaging, and the second microwave active component in extending below the base level extends downwards along the plinth.

10. A packaging for facilitating microwave heating according to claim 9 wherein the plinth is at least 6 mm high.

11. A packaging for facilitating microwave heating according to claim 1 wherein the first and second metallic microwave active components are joined to form a single component.

12. A packaging for facilitating microwave heating according to claim 11 wherein the single component contains a plurality of windows, the windows being defined by one or more holes in the component.

13. A packaging for facilitating microwave heating for a food product according to claim 12 wherein the dimensions and locations of the windows are adapted so as to be suitable for microwave heating a liquid food product or solid food product.

14. A packaging according to claim 1, which is in the form of a cradle, capable of being placed around and/or holding one or more microwave inert containers that contain the food product.

15. A packaging according to claim 14, which is re-useable.

16. A packaging according to claim 1 wherein the first and/or second metallic microwave active components comprise a metal film or foil.

17. A packaging according to claim 16 wherein the metal film or foil is an aluminium film or foil.

18. A packaging according to claim 17 wherein the aluminium film or foil is at least 1 μm thick.

19. A packaging according to claim 16 wherein the metal film or foil is a copper film or foil.

20. A packaging according to claim 19 wherein the copper film or foil is at least 0.6 μm thick.

21. A method of manufacturing a packaging for facilitating microwave heating for a food product, which method comprises the steps of:
(a) laminating or depositing a metallic microwave active component onto a support to produce a metallised element; and
(b) forming a packaging as defined in claim 1 from the metallised element.

22. A method of manufacturing a packaging for facilitating microwave heating for a food product according to claim 21 wherein the metallised element is incorporated into the packaging by in-mould labelling.

23. A method of manufacturing a packaging for facilitating microwave heating for a food product according to claim 22 wherein the in-mould labelling is barrier in-mould labelling.

24. A method of manufacturing a packaging for facilitating microwave heating for a food product according to claim 21 wherein the metallised element is a collar or a label to be placed around the packaging.

25. A method of manufacturing a packaging for facilitating microwave heating for a food product according to claim 24 wherein the label is an adhesive label.

26. A packaged food product comprising a food product packaged to a level at or below the fill level in the packaging for facilitating microwave heating as defined in claim 1.

27. A packaged food product according to claim 26 wherein the food product is an ambient stable, chilled or frozen food product.

28. A packaged food product according to claim 27 wherein the ambient stable, chilled or frozen food is a liquid food product at its consumption temperature.

29. A packaged food product according to claim 27 wherein the ambient stable, chilled or frozen food is a solid food product at its consumption temperature.

30. A packaged food product according to claim 27 wherein the ambient stable, chilled or frozen food is a mixture of solid and liquid food components at its consumption temperature.

31. A method for packaging a food product comprising the steps of:
(a) filling a packaging for facilitating microwave heating as defined in claim 1 with a food product; and
(b) sealing the packaging to package the food product.

32. A method according to claim 28 wherein the food product is an ambient stable, chilled or frozen food product.

33. A method according to claim 32 wherein the ambient stable, chilled or frozen food product is a liquid food product at its consumption temperature.

34. A method according to claim 32 wherein the ambient stable, chilled or frozen food product is a solid food product at its consumption temperature.

35. A method according to claim 32 wherein the ambient stable, chilled or frozen food product is a mixture of solid and liquid food components at its consumption temperature.

36-37. (canceled)
